(19) United States
(12) Patent Application Publication
(10) Pub. No.: US 2014/0028147 A1
(43) Pub. Date: Jan. 30, 2014

(54) Multi-Pole Electrodynamic Machine with a Constant Air Gap And An Elliptical Swash-Plate Rotor To Reduce Back Torque

(71) Applicant: CONVERGENT POWER, INC., Los Angeles, CA (US)

(72) Inventor: James F. Murray, Oklahoma City, OK (US)

(73) Assignee: Convergent Power, Inc., Los Angeles, CA (US)

(21) Appl. No.: 13/669,341

(22) Filed: Nov. 5, 2012

Related U.S. Application Data
(60) Provisional application No. 61/677,412, filed on Jul. 30, 2012.

(51) Int. Cl. H02K 1/24

(52) U.S. Cl. CPC H02K 1/24
USPC 310/216.074

(57) ABSTRACT

A Back Torque reducing electrodynamic generator machine is disclosed. Some embodiments include a multi-pole stator comprising field windings and power windings and a rotor having a flux path element. For some embodiments, the flux path element is attached to a rotor shaft at an oblique angle to the longitudinal axis of the shaft. The flux path element has a shape that provides a uniform constant air gap between it and the stator poles when the shaft is rotated.

### CROSS REFERENCE TO RELATED APPLICATIONS

The present application claims priority from U.S. Provisional Patent Application Ser. No. 61/677,412, filed on Jul. 30, 2012 and entitled “Multi-Pole Electric Electrodynamic Machine with a Constant Air Gap To Reduce Back Torque”, the disclosure of which is incorporated herein by reference in its entirety.

This application is also related to the following concurrently-pending applications: application Ser. No. 13/562,214, titled “Controller for Back EMF Reducing Motor;” application Ser. No. 13/562,199, titled “Three Phase Synchronous Reluctance Motor With Constant Air Gap And Recovery Of Inductive Field Energy;” and application Ser. No. 13/562,233, titled “Multi-Pole Switched Reluctance D.C. Motor with a Constant Air Gap and Recovery of Inductive Field Energy;” each of which are hereby incorporated by reference.

### FIELD OF THE INVENTION

The disclosed inventions relate to the field of electric power generation. More particularly, the disclosed inventions relate to an electric power generation device employing a constant dimension air gap and an elliptical swash-plate rotor that reduces the Back Torque present in the device.

### BACKGROUND

Existing electric energy generation devices have made incremental advances relating to improved magnetic materials, more powerful permanent magnets, and sophisticated electronic switching devices. Such improvements, at best, relate to small increases in overall efficiency, often gained at considerable expense.

Patents in this area include: U.S. Pat. Nos. 2,917,699; 3,132,269; 3,321,652; 3,956,649; 3,571,639; 3,398,386; 3,760,205; 4, 639,626 and 4,659,953. Also in this area are EPO patent no. 0174290 (3/1986); German patent no. 1538242 (10/1969); French patent no. 2386181 (10/1978) and UK patent no. 1263176 (211972).

The basic concept employed in earlier electrodynamic machine art, concerning generators, is the interaction between a moving conductor(s) and a magnetic field of some kind However, existing machines typically experience performance limitations due to the manner in which Back EMF (in motors), Back Torque (in alternators and generators), and inductive field energy (in general) are treated. One drawback of Back EMF is its parasitic nature that serves to degrade the potential supplied to the motor from an outside source (i.e., the source voltage). Likewise, Back Torque in electrical generating machines necessitates the application of additional prime-mover motive force (i.e., additional torque) in order to overcome degradation of the source torque and function on a continual basis.

The parasitic nature of Back EMF and Back Torque arises from, among other things, the mistaken assumption that Back EMF is required to produce torque in motors, and that Back Torque is required to produce generator action (and/or induce a voltage). This, in turn, leads to design compromises which must be made in order to implement traditional electrodynamic machine geometries. Consider, for example, a conventional DC Motor consisting of a stator with salient field poles, and a rotor-armature with a self-contained commutator. Application of a DC current to the rotor leads produces a rotary motion of the rotor (i.e., motor action). However, the rotation of the rotor conductors in a magnetic field also induces a voltage in the conductor that opposes the current applied to the rotor leads (i.e., generator action). These facts demonstrate an important aspect of conventional machines; if conventional design parameters are always followed, then any motor must perform as a generator while it is running, and any generator must perform as a motor while it is in operation. The explanation of this similarity is because both machines are dependent upon the same basic geometry for their functionality, and so, both motor and generator action occur simultaneously in both devices.

The above-described basic geometry of a conventional system results in the production of parasitic Back EMF in a motor as follows. In many traditional electric motor systems, the magnetic flux must interact with an electrical current-carrying conductor (e.g., rotor windings), thereby producing a mechanical force that generates a torque to turn the motor shaft (i.e., a motor action). The subsequent motion of the conductors through the magnetic flux produces a relatively high Back EMF (i.e., acts in opposition to the torque producing current) due to the motion of the conductors with respect to the magnetic flux (i.e., a generator action). In order to continue normal operation, and establish electrical equilibrium, any motor that produces a Back EMF having a constant average value, must draw down on the line-potential in order to overcome the effects of this parasitic reverse voltage. Thus, this process of source potential degradation due to Back EMF requires the input of considerable potential energy from the source in the form of a higher voltage in order to maintain normal operation.

In a conventional generator the production of parasitic Back Torque arises from the same principles. Mechanical torque is required to rotate the electrical conductors of the rotor (e.g., rotor windings) in the presence of a magnetic field (e.g., as produced by the stator field windings). This, in turn, produces an electrical current (e.g., in the rotor windings) that also interacts with the field and produces a relatively high Back Torque (i.e., acts in opposition to the torque driving the rotor). In order to continue normal operation and establish electrical equilibrium, any generator that produces a Back Torque requires a continuous supply of mechanical torque on the rotor from the prime mover in order to overcome the effects of the parasitic Back Torque and generate electricity. Thus, this process of source torque degradation due to Back Torque requires the input of considerable power from the prime mover source in order to maintain normal operation.

A different approach from the above and other existing devices is disclosed in the related U.S. Pat. No. 4,789,632, titled “Alternator Having Improved Efficiency,” to the same inventor of the present application, in U.S. patent application Ser. No. 12/993,941, which in turn is a 35 U.S.C. §371 filing of Application No. PCT/US09/46246, which in turn claims the benefit under 35 U.S.C. §119 to provisional Application No. 61/085,824, in U.S. patent application Ser. No. 13/390,437, which in turn is a 35 U.S.C. §371 filing of Application No. PCT/US10/45298, which in turn claims the benefit under 35 U.S.C. §119 to provisional Application No. 61/234,011, and in the above-noted related applications, each of which is hereby incorporated in its entirety by reference. The approach outlined therein generally involves, among other things, a canted flux path element as part of the rotor assembly and a constant dimension air gap between rotor and stator elements that reduces or realigns the Back EMF or Back Torque in motor and generator machines respectively.

As discussed above, conventional electrodynamic machines (e.g., motors and generators) are typically interchangeable in function (i.e., from motor to generator, or vice versa), by simply reversing shaft torque (i.e., using the applied field to produce shaft torque, or applying torque to the shaft to produce an output voltage). However, in the constant-dimension air gap, Back EMF and Back Torque reducing motor designs described in the above patents and applications of the present inventor, applying torque to a motor shaft will produce only a small output voltage, due to the unique rotor geometry which enables a constant air gap during operation. Typically, a Back EMF reducing motor of the disclosed designs when driven as a generator will produce a voltage substantially equivalent in magnitude to the Back EMF that would be produced by running the device as a motor. Likewise, a Back Torque reducing generator when driven as a motor will produce an output torque substantially equivalent in magnitude to the Back Torque that would be produced by running the device as a generator.

Therefore, in order to produce a typical, commercially desirable output voltage, some embodiments may incorporate an increased number of stator windings (relative to conventional machines) into a Back Torque reducing machine. An embodiment of this is also disclosed in the related U.S. Pat. No. 4,789,632 for a two-pole embodiment. Typically, relative to a comparable conventional machine, the presently disclosed stator designs will accommodate a greater number of windings per pole because each pole contains both field coils and power coils.

It is also, of course, possible to derive and calculate the operational characteristics of a multi-pole, Back Torque reducing machine in a manner similar to those provided in the above-referenced applications and patents. Further prototyping and testing may also be implemented to compile additional operational and performance data and principles.

An additional factor of Back Torque and Back EMF reducing designs is that the movement of the flux within the machine may produce eddy currents in the stator structures in more than one direction. Thus, in some embodiments, it is desirable to implement stator structures that reduce or compensate for such eddy currents. For example, stator shoe and pole pieces may be arranged with laminations of differing orientations in order to reduce eddy currents. Other configurations are also possible.

Drawbacks also exist in conventional generator designs as well as in Back Torque reducing designs. For example, in a typical generator the current inducing magnetic flux will “reverse” directions as the rotor turns. This, in turn, may cause hysteresis losses in the stator material.

Some existing generator designs employ a source of DC power to excite a magnetic field in the rotor in order to induce a current in the stator coils. Such a scheme typically requires slip rings, brushes, or commutators in order to supply the DC power to the rotor which adds to the complexity and cost of such a device, and can contribute additional losses to the system operation.

As noted, existing designs also create Back Torque which necessitates the input of additional mechanical torque from the prime mover equal in magnitude to the generator's reverse torque in order to overcome the Back Torque and produce the desired power. Other drawbacks also exist.

### SUMMARY

An electrodynamic generator machine is disclosed, some embodiments comprising a multi-pole stator comprising field windings and power windings and a rotor having a flux path element. For some embodiments, the flux path element is attached to a rotor shaft at an oblique angle to the longitudinal axis of the shaft. The flux path element has a shape that provides a uniform constant air gap between it and the stator poles when the shaft is rotated.

In an embodiment, the flux path elements comprise a silicon steel lamination stack or a solid ferrite plate. In a further embodiment, the stator poles are positioned in pole pairs with the rotor and rotor shaft between them and form isolated stator magnetic field circuits when the stator windings are supplied with electrical current, such that a magnetic field is established having a single magnetic polarity in each of the poles of said pole pairs, with each pole of the pole pairs having opposite magnetic polarity. In further embodiments more than two poles are installed in each stator section and share the magnetic permeability of a common rotor structure.

In a further embodiment, the rotor flux path elements have a shape defined by the volume contained between two parallel cuts taken through a right circular cylinder at an angle other than 90 degrees with respect to the axis of symmetry of said cylinder, each flux path element having front and back faces that are substantially elliptical, and having major and minor axes. In an embodiment, the flux element angle with respect to the axis of symmetry is substantially 45 degrees.

In a further embodiment, the electrodynamic machine has rotor counterweights to statically and dynamically balance the eccentric mass of the rotor flux elements.

One advantage of the presently disclosed system and method is that it addresses the drawbacks of existing systems.

Another advantage of the presently disclosed system is to provide an electrodynamic machine that develops a significantly reduced Back Torque.

Another advantage of the presently disclosed system is to provide an electrodynamic machine that makes use of a plurality of salient poles within its stator structure that may possess characteristics different than typically employed by existing systems. For example, the stator poles should be arranged or constructed to be protected from flux movement in two directions in order to minimize eddy currents, and related iron losses. For example, fabricating all or part of the pole pieces from different metals, using grain orientation, using ferrite materials, using distributed air gap material, or laminations disposed at right angles with respect to one another, are some techniques that may be implemented to inhibit the production of eddy currents, and thereby lessen iron losses.

One embodiment of the presently disclosed system employs a rotor fabricated from a stack of steel disks, chemically insulated from one another to discourage and reduce eddy currents. The disks may be pressed upon an arbor which, in turn, is obliquely disposed with respect to the intended axis of rotation, and suitably machined so as to produce an assembly with a peripheral contour generally equivalent to that of a cylindrical segment. The stator may be composed of a plurality of salient pole sets, each set comprising a pair of poles, and associated windings, arranged 180 degrees apart from one another upon the stator, and each pole set angularly displaced from one another by a desired number of mechanical degrees.

In some embodiments, each pole set may also be provided with a concave pole face, whose radius is slightly greater than the radius of the rotor. The rotor, therefore, defines an air gap of continuous dimension when rotated despite the elliptical nature of the rotor. The rotor is in magnetic series with each set of magnetic poles, thereby completing the magnetic circuit, and the rotor reacts to each set of energized poles by undergoing a mechanical displacement equal in degrees to the pole set's mechanical distribution around the periphery of the stator assembly. As the rotor rotates, the zone in which the flux is coupled to the active pole pieces may vary in position along the length of each pole face. However, the width of the air gap separating the pole face from said rotor will not vary.

This arrangement permits the magnetic potential within the air gap to remain substantially constant, but redirects the Lenz force vector such that its magnitude is diluted by the oblique angle of the rotor thereby minimizing the development of a large Back Torque.

For existing conventional generator designs, the frequency of the output current is a function of the number of poles, the angular speed of the machine, and the number of coils involved. However, the conditions which influence the operational frequency of the device disclosed herein are notably different. In some embodiments of the disclosed machine, the output frequency is a direct function of power coil placement, shaft speed, and the unexpected fact that the flux has a rate of change with respect to position, not just with respect to time.

Thus, for some embodiments, the electrodynamic machine's output frequency effectively involves a relativistic effect, which introduces harmonics under controlled conditions, and has an effect upon both voltage wave shape, and the system periodicity. For some embodiments, the net effect is that a two pole Back Torque reducing machine as disclosed herein can provide its load with a 60 cycle output while turning at an angular speed of 1800 RPM, as opposed to a conventional device which must turn at 3600 RPM to achieve the same effect with two poles. Subsequently, a four pole electrodynamic machine as disclosed herein may enable a shaft speed of only 900 RPM to produce a 60 cycle output. Therefore, in some embodiments, one advantage of the disclosed designs is to provide an electrodynamic machine capable of producing higher-frequency output, per shaft revolution, per pole set than is found in existing devices.

Other aspects and advantages of the presently disclosed systems and methods will now be discussed with reference to the drawings.

### BRIEF DESCRIPTION OF THE DRAWINGS

FIG. 1 is a horizontal section of an embodiment showing the maximum dimension of the rotor disposed adjacent to the end portions of the pole pieces.

FIG. 2 is a horizontal section of an embodiment showing the minimum dimension of the rotor disposed adjacent to the central portions of the pole pieces.

FIG. 3 is a horizontal section of an embodiment showing the rotor turned 180 degrees in the direction of the arrow from the position shown in FIG. 1.

FIG. 4 is a vertical section of an embodiment taken along the line 4-4 in FIG. 1.

FIGS. 5A-5F are schematic representations of horizontal sections of the invention showing the magnetic flux between the stator and rotor for six different rotational positions for one rotation of the rotor with respect to only one set of field poles.

FIGS. 6A-6B are schematic representations depicting the interaction of magnetic and mechanical forces within embodiments of the disclosed electrodynamic machine.

FIGS. 7A and 7B are schematic illustrations of magnetic flux, electric field, and velocity components within stator iron.

FIGS. 8A and 8B are schematic end view and side views of certain stator components in accordance with some embodiments of the disclosed inventions.

FIG. 9 illustrates a conceptual diagram of the generation of an ellipse that, when rotated, has a cylindrical cross-section.

FIGS. 10A and 10B illustrate an end-view cross-section and a side view cross section, respectively, of a four pole electrodynamic machine in accordance with some disclosed embodiments.

### DETAILED DESCRIPTION

In the following detailed description, reference is made to the accompanying drawings that form a part hereof, and in which is shown by way of illustration specific embodiments in which the invention may be practiced. These embodiments are described in sufficient detail to enable those skilled in the art to practice the invention, and it is to be understood that other embodiments may be utilized and that various changes may be made without departing from the spirit and scope of the present invention. The following detailed description is, therefore, not to be taken in a limiting sense.

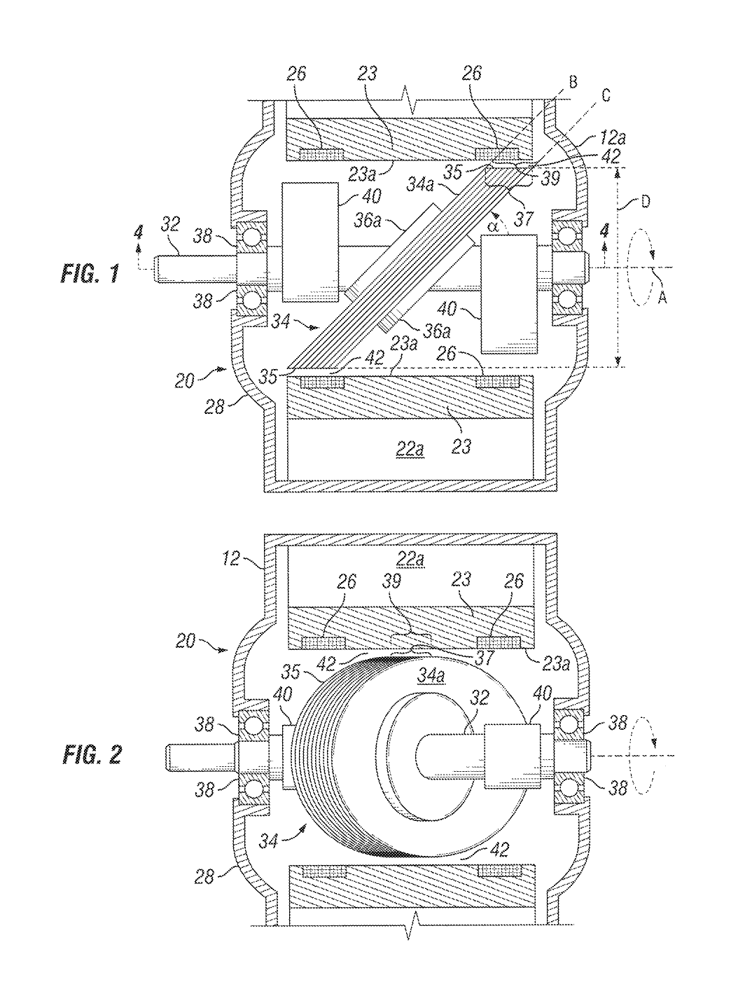

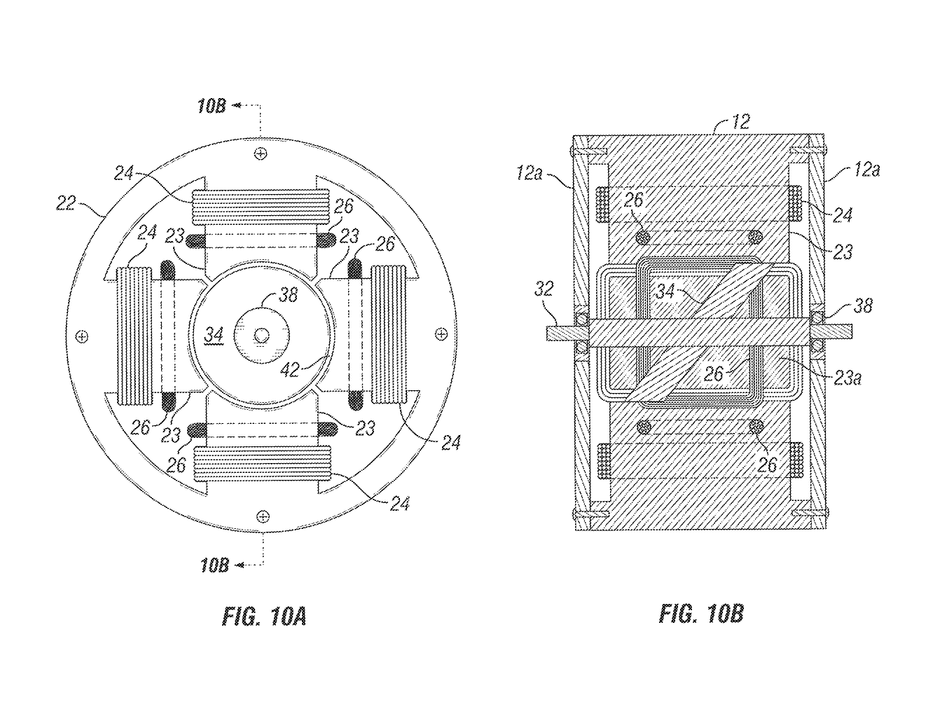

As shown in FIGS. 1-4, and 10A and 10B some embodiments of the disclosed electrodynamic machine 20 may comprise a stator assembly 22 and a rotor assembly 30 disposed within a housing 12. For some embodiments, the stator assembly 22 may generally form a hollow cylinder which may be formed of a highly permeable material, silicone steel laminations, sintered steel alloys, special solid steel forms, distributed air gap material, or the like, and is provided with pole pieces 23 which extend radially inwardly and terminate in concave faces 23a. While two pole pieces 23 are evident in the cross sectional views of FIGS. 1-3, the presently disclosed embodiments incorporate 2N poles in a multi-pole configuration, where N is an integer. For example, the cross sectional view of FIG. 4 illustrates a four pole (N=2) embodiment.

For some embodiments, each pole piece 23 may carry two sets of windings. Field windings 24 may be carried on the stator pole 23 in a convenient location, for example, at the portion 22a. Other configurations are also possible. Any suitable field windings 24 capable of producing the desired magnetic field are possible.

For some embodiments, power windings 26 may also be carried by the stator assembly with one or more windings on each pole piece 23. For example, power windings 26 may be located in slots extending in to the face 23a of each pole piece 23.

Of course, the slots should be of sufficient depth and width to insure that the power windings 26 disposed in them do not protrude into the air gap 42. Other configurations of power windings 26 are also possible.

An embodiment of rotor assembly 30 is shown comprising a shaft 32 that carries a rotor 34 within the hollow cylinder defined by the stator body. For some embodiments, shaft 32 may be positioned on suitable bearings 38 mounted in each of the opposite end bells 12a of the casing 28.

A prime mover (not shown), may be connected to shaft 32 to provide a driving torque. In some embodiments, rotor 34 may be fabricated from material having high permeability, such as, silicone steel laminations, sintered steel alloys, distributed air gap material, or the like, to, among other things, reduce or minimize eddy currents. The rotor 34 may be secured to shaft 32 by an arbor 36a or the like. Of course, other configurations, such as a unitary machined rotor and shaft, or other mounting devices, may also be implemented. Counterweights 40 may be mounted on the shaft 32 to provide a balanced rotational mechanical structure.

In some embodiments, the form of the rotor 34 as shown in FIG. 1, is a section of a cylinder having a diameter D and an axis A, which is cut by two parallel planes “B” and “C.” In one embodiment, angle “α,” between planes C and shaft 32 may be 45 degrees. Other angles are also possible.

FIG. 1 shows an embodiment of the rotor assembly 30 at the beginning of a cycle of rotation when the rotor is seen as if on edge. FIG. 2 shows the rotor assembly 30 viewed 90 degrees from the position of FIG. 1. In the position show in FIG. 2, the face 34a of the rotor 34 can be seen, for this embodiment, to be elliptical.

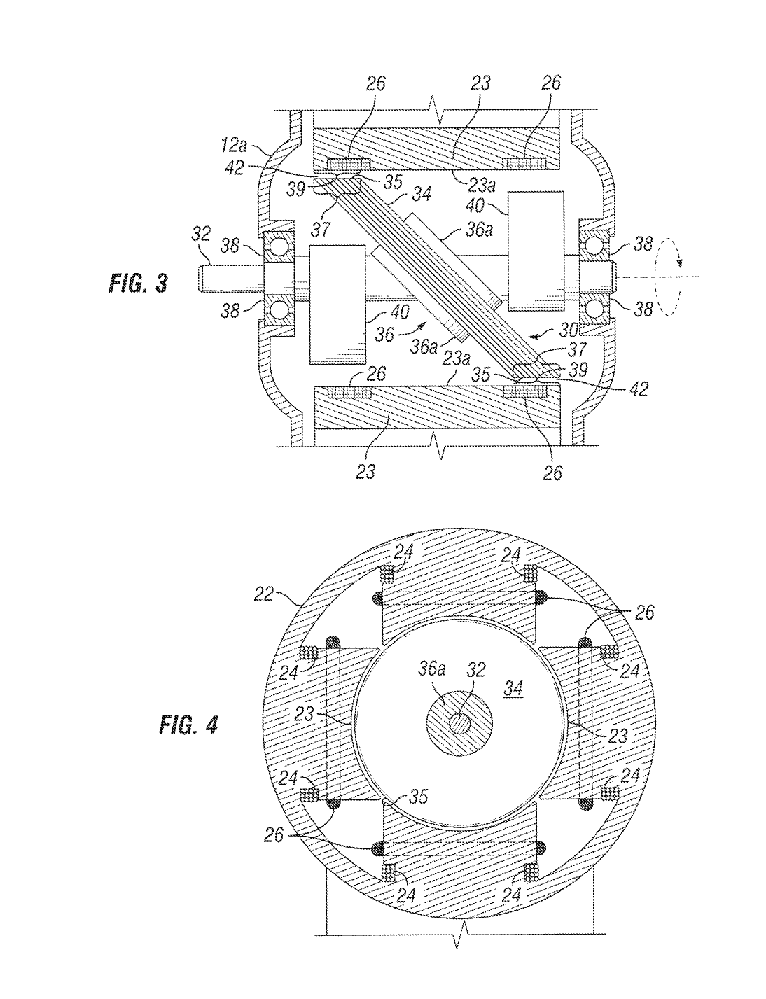

FIG. 3 shows an embodiment of the rotor assembly 30 after a movement of 180 degrees from the position shown in FIG. 1. The areas on the rotor edge 35 and a portion of the faces of the pole pieces 23 are referred to herein as coupling zones 37 and pole face flux zones 39, respectively. As described herein, for some embodiments pole face flux zones 39 oscillate along the length of each pole face 23a with periodic motion (e.g., simple harmonic motion) as the rotor assembly is revolved. Thus, the position of the upper pole flux zone 39 as shown in FIG. 1 is located at the right-hand end of the pole face, while the same zone 39 as shown in FIG. 2 is located near the center of symmetry of the power winding 26, and as shown in FIG. 3, this zone 39 has travelled to the left-hand end of the pole face 23a. Thus, as the rotor assembly 30 turns through the next 180 degrees, the flux zones 39 return to the position shown FIG. 1. Thus, for these embodiments, these zones 39 execute periodic motion (e.g., simple harmonic motion) back-and-forth along the pole faces 23a.

In accordance with some embodiments, the presence of an excitation current in the field windings 24 and the application of a torque (e.g., by a prime mover) to shaft 32 will operate as follows. The current flowing in the field windings 24 produces a stationary magnetic field in the stator iron 22 with the lines of flux tending to flow in the magnetic circuit by following the path of least reluctance, as illustrated with reference to the four-pole embodiment shown in FIG. 4. Starting at the left most pole piece 23 in FIG. 4 (i.e., the one at the 9 o'clock position), flux will flow through the stator 22 to the flux zone 39 of pole pieces 23. From there, flux will pass across the air gap 42 to the flux zone 37 of the rotor 34, returning across the air gap 42 to the pole pieces located 90 mechanical degrees away (i.e., the pole pieces at 12 o'clock and 6 o'clock), and then back through the stator. Thus, the rotor magnetically couples the pole faces 23, by providing a low-reluctance path between the relevant pole pieces. A similar, mirror-image path is followed by the flux due to the pole piece 23 on the right most side (i.e., 3 o'clock) of FIG. 4. Since the peripheral portions of the rotor are parallel to the pole faces, the flux density in the air gap will remain constant while the flux region oscillates across the relevant pole faces with simple harmonic motion.

While certain embodiments are disclosed herein, it is also possible configure the machine with alternative components. For example, in some embodiments of the electrodynamic machine any suitable type of bearing 38 may be implemented depending on the design circumstances, intended implementation, environment of application, or the like. Thus, bearings 38 may be single roller bearings, multiple-roller bearings, thrust bearings, conical bearings, metallic sleeve bearings, or other suitable type of bearing.

Likewise, for embodiments where magnetically conductive rotor stack 34 is mounted in a canted position with respect to shaft 32, it may be desirable to include rotational stabilizers 40 to dynamically balance the rotation of the shaft 32. Any suitable stabilizers 40 may be implemented. For example, in some embodiments stabilizers 40 may take the form of machined metallic rings containing distributed tungsten weights to achieve dynamic balance. Other configurations are also possible.

Likewise, in some embodiments, the arbor 36a may comprise any suitable arbor or mounting mechanism for securing the rotor stack 34 to the shaft 32. For example, in some embodiments, where rotor stack 34 comprises a laminate stack, it may be desirable to use a compression arbor 36 that facilitates the securing and positioning of the laminate. Furthermore, arbor 36 may be formed from any non-magnetic alloy, compound or element which may serve to enhance generator performance. Of course, other arbors 36 may be implemented depending upon factors such as the type of shaft 32, design of the rotor stack 34, as well as other factors.

As noted, in some embodiments, magnetically conductive rotor stack 34 may comprise a stack 34 of individual disks fastened together. In other embodiments, stack 34 may comprise a unitary structure, or other similar solid magnetically conductive path. In still other embodiments, stack 34 may be replaced with any suitable magnetic material that enhances motor performance, including, but not limited to, various steel alloys, various paramagnetic materials, and distributed air-gap materials such as sintered steels and the like.

Further, in some embodiments the stack 34 is fashioned to present a substantially cylindrical profile, such as one described with reference to FIG. 9, thereby ensuring an air gap with the stator of constant, or substantially constant, dimension at the cost of a relatively slight increase in magnetic circuit length. Such an arrangement facilitates a minimum change in magnetic potential energy across the air gap, thereby restricting the dΦ/dt voltage to a minimum, while allowing the speed voltage to have maximum effect upon the electric circuit as the flux interacts with the conductors imbedded in the wire slots of each pole face. This process highlights the exact opposite parameters found within embodiments of a Back EMF reducing motor, such as those disclosed in the related applications noted above, thereby maximizing the difference between embodiments of generator and motor geometries.

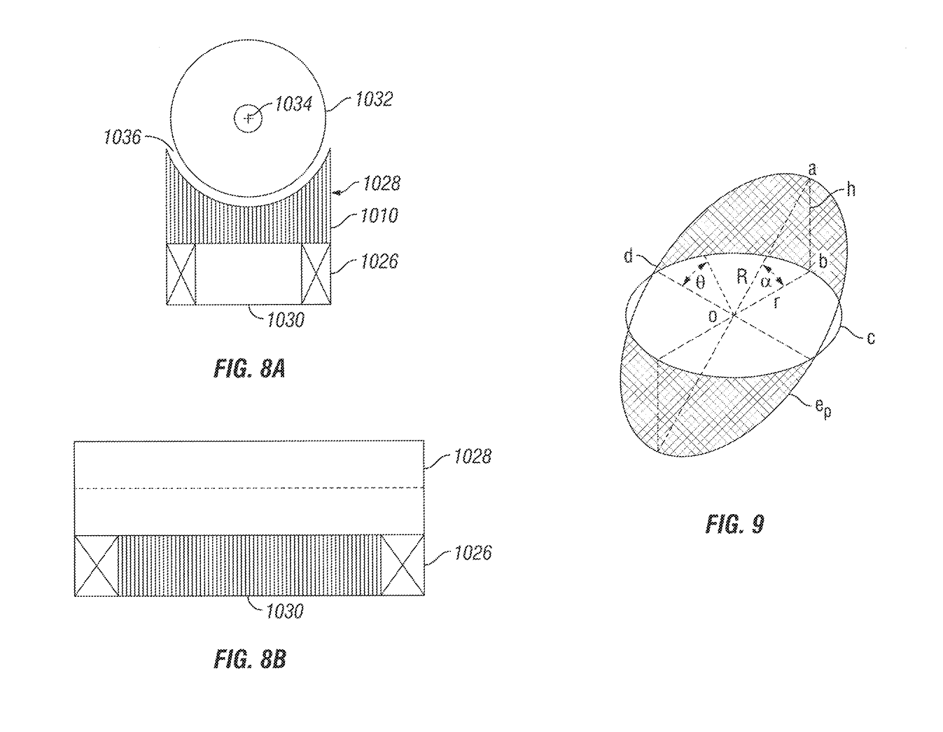

As discussed in connection with FIGS. 8A and 8B, embodiments of the electrodynamic machine's stator poles and stator stack may comprise laminations or other material to optimize magnetic flux production without inducing detrimental eddy currents. Other embodiments of the stator assembly, and the components of the same, may also be implemented.

For some embodiments implementing a multi-pole stator assembly, the stator assembly 22 may comprise silicone steel laminations, sintered steel alloys, distributed air gap material, or any other material which may suppress the formation of eddy currents and enhance motor efficiency and performance. Further, for some embodiments the stator assembly may have at least four (4), diametrically opposed salient pole projections 23, situated at even angular increments around the stator periphery, and aligned in pole pairs 180 mechanical degrees apart, but with pole polarity that alternates from North to South and from South to North for every 90 mechanical degrees so as to constitute a complete magnetic path through the rotor at all times. Other configurations are also possible.

Some embodiments of the device include multipolar arrangements with salient poles placed at 90 degree intervals, or sub-divisions thereof, such as 45 degrees, 22.5 degrees, etc. However, a particular device's physical constraints (e.g., space limitations), as well as magnetic constraints (e.g., interference from adjacent poles) should be considered as necessary for a given application of the device.

As discussed, in some embodiments, each salient pole projection 23 supports an electrical winding or coil 24 that develops a magnetic field in response to the passage of a current through the field winding 24. This field provides a magnetic force which acts upon, and is correspondingly acted on by, the rotor assembly 30.

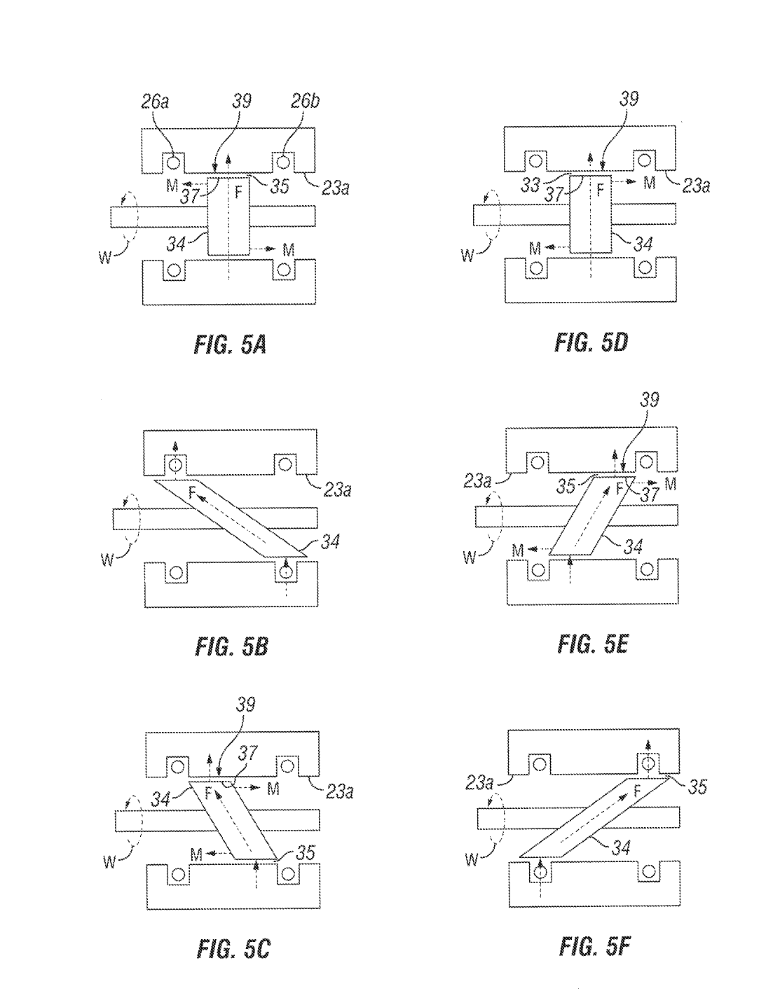

A more detailed description of flux movement may be gained with reference to FIGS. 5A-5F which are each a schematic representation of a cross-section of a face 23a of a pole piece 23 and the opposing rotor edge portion 35 of the rotor 34, taken at different points during one cycle of rotation of the rotor 34 in accordance with some embodiments of the invention. Again, as the view is cross-sectional only one pair of pole pieces 23 is shown. However, the same motion of the flux zones 37, 39 will occur in a similar manner on each pole of the device, although in opposite mechanical phase (i.e., 180 degrees out of phase).

FIG. 5A depicts a point in the rotor cycle at which the flux zone 39 is located midway between the conductors of power winding segments 26a and 26b. As noted above, the rotor geometry results in the flux zones being moved reciprocally back and forth across the faces 23a of the pole pieces 23. As shown in FIG. 5A, the rotor edge (and thus, the flux zone 39) is being accelerated in the direction of arrow M, toward power winding segment 26a.

FIG. 5B depicts the situation after 90 degrees of rotor 34 rotation in the direction of the arrow. Here, the flux zone has moved to overlap power winding segment 26a with rate of change of flux becoming zero. Accordingly, the voltage in the power winding 26 becomes practically zero. This is the location at which the point of reversal in direction of the flux zone takes place.

FIG. 5C shows the situation after another 45 degrees of rotation. The pole face flux zone 39 has returned part way toward the midpoint of the power winding 26 in a direction extending toward power winding segment 26b.

FIG. 5D depicts the condition at 90 degrees of rotation with the pole face flux zone 39 at the midpoint between winding segments 26a and 26b.

In FIG. 5E there is shown the condition after another 45 degrees of rotation.

In FIG. 5F, the pole flux zone 39 is at an extreme point of movement relative to the pole piece face 23a and including power winding segment 26b. No directional arrow is shown since the zone 39 is momentarily at rest with respect to the pole piece face 23a. In this way, a full cycle is completed for some embodiments.

For such embodiments, the position of maximum flux concentration alternates from a relative zero position to a maximum displacement twice each cycle without undergoing a reversal of its magnetic polarity. It is understood that the flux density does not vary sinusoidally in the angular sense, but exhibits a complex variation in position which can be expressed mathematically as a spatial harmonic wave.

Furthermore, for these embodiments, because the flux never reverses polarity, the “iron” domains within the pole pieces 23 will not exhibit major hysteresis loops usually associated with oscillating flux. In this manner, embodiments of the disclosed systems drastically reduce the hysteresis losses which are particular to all flux-reversing systems. In addition, cooling requirements for such embodiments of the alternator are likewise reduced since smaller quantities of heat are generated by the reduced hysteresis losses in the pole pieces 23.

In some embodiments, the motion of the rotor 34 causes a simple harmonic motion of the magnetic flux across the pole faces, such that, despite the substantially constant flux density, the flux position becomes a direct function of shaft speed. Hence, actual flux velocity across each pole face becomes proportional to some maximum flux density value, B, times the simple harmonic velocity, v. Accordingly, the speed voltage, Vs=B(vₘₐₓ sin cot); this equation represents the motional portion of the induced voltage. However, considering the “transformer voltage” component, Vt, which is equal to some expression involving dΦ/dt. Therefore, the total voltage will be the sum of the speed voltage Vs, and the transformer voltage Vt, with a mathematical result approximating V_{Total}=[B(vₘₐₓ sin ωt)]+(dΦ/dt).

In two-pole embodiments, the induced voltage in the power windings 26 oscillates through a complete cycle for every 180 degrees of rotation of the rotor 34. Thus, the induced voltage has twice the frequency of the harmonic velocity of the flux and the angular velocity of the shaft 32. This fact has an important consequence, as the prior art teaches that a two-pole alternator can generate only one cycle of current for each revolution of the rotor. Thus, the prior art requires that a two-pole alternator must operate at 3600 r.p.m. in order to generate 60 cycle alternating current. By contrast, with the alternator of the current invention a two-pole machine can produce 60 cycle alternating current at 1800 r.p.m.

By extension of the above characteristics, a four pole machine could produce 60 cycle alternating current at 900 r.p.m, and an eight pole machine can produce the same 60 cycle current at 450 r.p.m. The ability to operate at lower r.p.m. is advantageous and reduces the wear on mechanical components of the machine, can offer increased reliability, and longer machine life. The presently disclosed embodiments of the electrodynamic machine also result in a reduction of iron-related losses which are proportional to rotor speed, as well as loses stemming from mechanical friction and windage. Other advantages also exist.

Embodiments of the herein-disclosed rotor geometry and multiple salient poles upon the stator will create an electrical phase for each additional pole set. Accordingly, a two pole embodiment will generate a single phase output, a four pole embodiment will generate two phase output, an eight pole embodiment will generate four output phases, a sixteen pole embodiment will generate eight output phases, etc.

Various connection configurations exist to handle the phased output. For example, some embodiments may employ rectification of each output phase together with the summation of each phase's power on a common DC output bus. Other embodiments may employ a series interconnection of AC phases such as to produce a single phase AC output. This configuration is called a zigzag connection, and it is typically applicable in environments where the final electrical output phase relationship does not interfere with the energy feedback mechanism. Other phase handling output configurations are also possible.

In an inductive circuit, such as that of the power windings of an electrodynamic machine configured as an alternator, it is well-known that a certain component of the current flows in a reactive relationship to the induced voltage. This “produces” a “reactive power component” referred to as “volt-amperes reactive,” or “VAR” power. The average value of reactive power is zero, and it can make no contribution to the consumed power such as a resistive load. However, in embodiments of the disclosed machine, due to the fact that the flux changes its direction mechanically, the energy stored in the VAR component can be transformed into useful mechanical work, and assist the prime mover in rotating the rotor shaft.

For some disclosed embodiments, the rotor is constantly oscillating the space angle, and, thus, a portion of the converted power, between the real power domain and the imaginary power domain. Thus, when the rotor is in the real power domain, VARS appear as imaginary power and watts are real. Likewise, when the rotor is in the imaginary power domain, VARS appear real and Watts appear imaginary (note the following definitions: Watts (resistive loads), +VAR's (inductive loads) and −VAR's (capacitive power)).

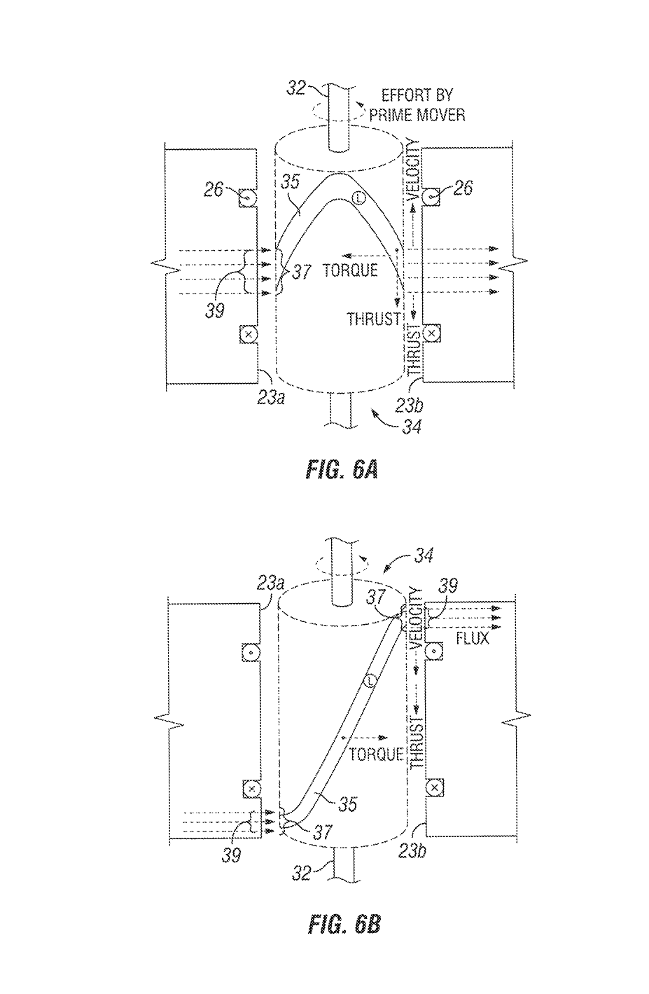

The basis of this concept can best be grasped by referring to FIG. 6A. This drawing shows an embodiment with an elliptical rotor 34 pictured within its cylindrical surface of revolution. At the instant depicted, the rotor 34 is so positioned that the flux is centered on each pole face, and is passing through the axis of symmetry of elliptical rotor 34. As rotation proceeds, from left to right, the flux in the left pole face is moved in a downward direction, and begins to induce a voltage in 23a, the flux in the right pole face is moved in an upward direction and begins to induce a voltage in 23b. Assume for simplicity and by way of example, that the power coils 26 are connected in additive series, and that their output is short circuited. This will ensure that the windings are the only active components in the circuit, and that the power produced in them will be substantially reactive. As current starts to build within the coils 26, an opposing force due to the Lenz reaction will attempt to thrust the flux in a direction opposite to that of its motion. This thrust will be parallel to the axis of rotation of shaft 32, and in an opposite sense for each pole 23. The action of these forces upon the rotor 34 will be analogous to that of followers in the groove of a cylindrical cam. Hence, these lateral thrusts will be converted into “diluted” torques that oppose the effort of the prime mover for one quarter cycle, and provide assistance over the next quarter cycle.

Because of the lateral oscillation of the external magnetic field rather than the usual rotary movement, the current carrying conductors will still develop powerful forces in accordance with Lenz's law. In this case though, the force is directed parallel to the axis of rotation, thus, only a minor vector component interacts with the torque necessary to spin the rotor. Unlike conventional systems where the resulting Lenz force attempts to deplete torque (i.e., Back torque), in this case a percent of the effort made by prime mover is reflected at the limits of travel of the rotor such that it assists rather than retards the torque provided by the prime mover. The power for this operation is provided by the reactive power in the system. This mechanism therefore decreases the average torque required to rotate the machine. The system may be considered to function as a non-linear spring, compressing and expanding in synchronicity with each electrical cycle. As a result power may be directed back toward the prime mover, where it is stored as kinetic energy in the mass of rotor, and can be reused at the start of the next successive electrical power generation cycle.

As an analogy, or explanation, of the above-imagine a child on a swing set who swings all the way to the top position possible on the swing, and instead of letting them go around the other side you pull an imaginary rope ever so slightly and they come back toward you with full force.

In FIG. 6B, the drive shaft 32 has rotated 90 mechanical degrees, and the lamination stack has traversed a space angle of 90 degrees relative to the pole faces. At the instant depicted, the harmonic velocity of the surface of the rotor 34 relative to the pole faces is exactly zero, but about to reverse. At this point in time, the reactive current in each winding 26 is just reaching its maximum value because it is 90 degrees out of phase with the induced voltage. Hence, as each edge 35 of the rotor 34 begins to accelerate in the opposite direction, relative to the pole faces, magnetic forces produced by the current in each winding now attract the flux, and develop thrusts which operate in the same direction as that of the motion. Due to the cam-like design of this embodiment of the rotor 34, these actions give rise to torques which now assist the effort of the prime mover for the next quarter cycle which contributes to an increased overall system efficiency and requires less input power from the prime mover.

Because embodiments of rotor 34 comprise a magnetic material canted at a specific angle, rotor 34 possesses mechanical properties as well as magnetic properties. Accordingly, embodiments of the rotor 34 can operate as a swash plate when it is impinged upon by forces which are parallel to the axis of rotation. Therefore, when Lenz forces appear as a result of the interaction between the generated current, and the stationary magnetic field, a force, or “thrust” will appear and act upon the rotor 34. The face angle of the rotor 34, or its tilt, will act to dilute this force, as in the case of a cylindrical cam. However, when the rotor edge 35 reverses direction at the 180 degree position, the retarding force, or Lenz reaction, will be augmented by the shaft torque, thus off-loading the prime mover for a portion of one electrical cycle. This effect lowers the average torque requirement, and lessens the power contribution for the prime mover.

One periodic change in induction is synchronized with the occurrence of maximum current within the circuit. This change in volume of the circuit energy requires no additional work input from the prime mover and produces a net gain in power production. In this method of energy transformation, power flow oscillates between the mechanical and electrical domains such that unused reactive power is periodically converted to angular kinetic energy after which it can be dissipated in the electrical load. The parametric pumping of the main inductance modulates the magnetic energy associated with the current flow. This gives form to a second order resonance that associates itself with an oscillation of energy between the mass of the alternator's rotor and the magnetic induction of the power windings situated in the stator structure.

This form of energy resonance does not require capacitance within the electrodynamic machine's electric circuit. Rather, energy is stored within the rotor's mass and produces reversals in shaft torque which in turn provides rotational assistance to the prime mover.

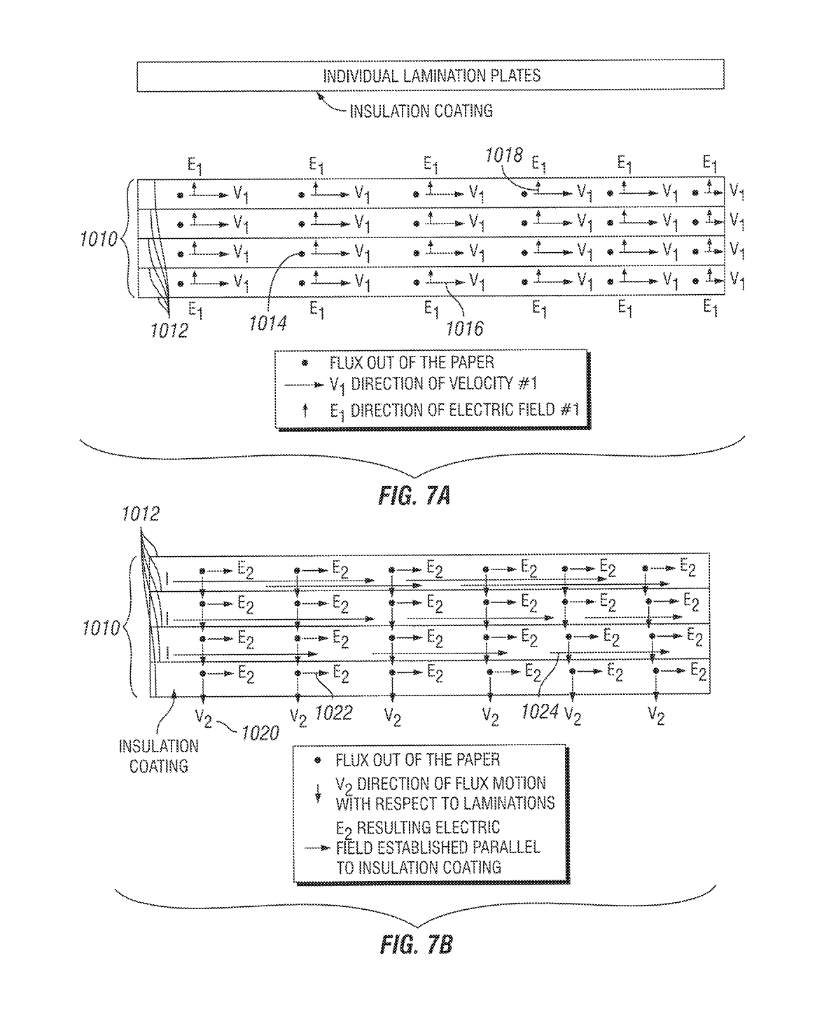

As explained herein, and with reference to FIGS. 7A and 7B, the disclosed machine will experience two distinct, internal flux movements, each of which may induce eddy currents of different directions within the machine steel. FIG. 7A is an illustration of a portion of some stator lamination plates 1010 in accordance with some embodiments of the disclosed machine. Each lamination plate 1010 may also comprise an insulating coating 1012 on the outer surfaces. As shown, a magnetic flux field 1014, indicated as coming out of the page by the dots as shown, experiences a first velocity (v₁) indicated by arrows 1016 pointing to the right, and an electric field (E₁), indicated by the arrows 1018 pointing to the top of the figure. This field (E₁) produces a relatively insignificant eddy current because the insulating coating 1012 between each plate inhibits the current flow. However, as shown in FIG. 7B, when a second direction of motion (v₂) is experienced as indicated by the arrows 1020, such motion will produce a second electric field (E₂) as indicated by the arrows 1022. Because this field (E₂) is established between the insulating coatings 1012, eddy currents (I) as indicated by arrows 1024 will flow within the metal lamination plates 1010.

FIGS. 8A and 8B illustrate an end view and a side view of stator pole arrangements in accordance with some embodiments of the disclosed machine that enable the minimizing of the eddy currents in the salient poles due to flux movement in two directions as described above. As shown for this embodiment, a stator pole may comprise a top pole piece (called a shoe) comprising vertically disposed laminations 1028. A bottom portion of the pole may comprise standard, or radially disposed, laminations 1030. Other arrangements of laminations are also possible, the concept being that the layers of the various portions are arranged to minimize eddy currents by inhibiting current flow.

Also illustrated for this embodiment in FIGS. 8A and 8B are stator field windings 1026 for generating the magnetic flux fields, rotor 1032, rotating about an axis of rotation 1034, and constant air gap 1036 between the edge of rotor 1032 and stator shoe 1028. Not shown here, are the power windings 26 which are used in generator action. For some embodiments, power windings 26 may reside at or in slots within shoe 1028.

Additional embodiments of stator poles may also be implemented to minimize eddy currents. For example, another embodiment is to have the pole face, or shoe 1028, made of a material such as sintered steel, ferrite, or distributed air-gap material, and then bond, or otherwise fasten, the shoe 1028 to the bottom portion 1030 of the stator pole. Likewise, other embodiments may also implement stator pole pieces comprising grain-oriented steel, with the grain best oriented for lateral flux movement. Embodiments employing combinations of these techniques for eddy current minimization are also possible.

Likewise, for some embodiments, the salient poles are designed to be as short as is optimal in order to optimize the overall magnetic circuit length. This has the advantage of also lessening iron losses.

Finally, for some embodiments, the design of the pole field windings (e.g., windings 1026) is to be of adequate wire size, but with a number of turns that is optimal. This has the advantage of keeping I²R (i.e., copper) losses to a minimum. The wire size and number of turns are preferably optimized so that enough turns are used to establish a magnetic flux of sufficient magnitude, while also keeping the I²R losses to an optimal minimum. Typically, relative to a comparable conventional machine, the presently disclosed stator designs will accommodate a greater number of windings per pole because each pole contains both field coils and power coils.

As noted previously, the rotor design features of the presently disclosed invention also contribute to the herein described performance. As discussed above, an important feature of the disclosed rotor is that it be shaped to assist in the reduction of the factors that contribute to the generation of Back Torque. To that end, rotors that exploit the design principles in accordance with the present disclosure will be designed to form a constant, or substantially constant, air gap with respect to the stator poles.

In addition, a rotor designed in accordance with the disclosed embodiments of the invention will also facilitate the creation of a variable length magnetic circuit path. In general, one way to design a rotor capable of creating a variable length magnetic circuit path is to create an ellipse that, when rotated, retains a circular cross-section. For some embodiments, such an ellipse may be created in the manner illustrated in FIG. 9.

FIG. 9 illustrates a conceptual diagram of the generation of an ellipse that, when rotated, has a circular cross-section. As shown, such an ellipse can be generated by drawing a reference circle c with a radius r. Projecting out of the plane of the circle c, a height h is generated from r sin α, where α is that angle of inclination of the hypotenuse R (of triangle a0b) from the plane of circle c, and where θ represents the angles generated about the point 0 in the plane of circle c. Thus, the triangle a0b is formed having a radius value of R=(r²+(r sin α)²)^{1/2}. If the height (h) of the triangle a0b is varied sinusoidally in accordance with the angle θ, then for a given θ, the instantaneous angle of slope may be calculated by the following relation, S=A tan (cos α). Plotting an infinite number of similar triangles about 0 for the full 360 degrees of circle c produces an ellipse of perimeter eₚ as shown in FIG. 9. Ellipse eₚ will always have a circular cross-section when rotated about 0 in the plane of circle c. Additional rotor designs suitable for implementation of the concepts presently disclosed are also possible.

Another aspect of embodiments of the disclosed electrodynamic machine may be illustrated with reference to performance under the application of an electrical load to the device. The application of a load to most conventional generating devices produces a secondary magnetic field which opposes the generator's field flux, thereby causing a reduction in output voltage. This “voltage drop” is then countered by increasing the current delivered to the device's field windings, which in turn boosts the output voltage. However, the presently disclosed electrodynamic machine has the heretofore unexpected behavior of increasing its rotational speed as the output impedance approaches a short circuit.

Naturally, this kind of behavior can be controlled, and so here we have the basis of a type of regulator which may interact with the prime mover providing a “governor” action, as well as controlling the output voltage. For example, in some embodiments a mechanism in place between the prime mover and the electrodynamic machine could be used to prevent any overspeed condition due to a shorted load from affecting the increased speed of the electrodynamic machine from impacting the prime mover.

While the invention has been described in detail and with reference to specific embodiments thereof, it will be apparent to one skilled in the art that various changes and modifications can be made therein without departing from the spirit and scope thereof. Accordingly, it is intended that the present invention cover the modifications and variations of this invention provided they come within the scope of the claims and their equivalents.

What is claimed is:

1. An electrodynamic generator machine comprising:
a stator assembly comprising:
at least two salient poles arranged to minimize eddy currents, hysteresis loops, or iron losses by protecting from flux movement in at least two directions;
at least one field winding that when energized creates a magnetic flux; and
at least one power winding that, upon experiencing a change in magnetic flux, generates an induced voltage;
a rotor assembly comprising;
a shaft;
a flux path element mounted on the shaft and configured to direct magnetic flux through a flux zone, and wherein the flux path element is further configured to magnetically couple pairs of the at least two salient poles by providing a low-reluctance path between the pairs, and
wherein the rotation of the shaft enables the flux path element to vary the location of the flux zone in a periodic fashion; and
the stator assembly and the rotor assembly positioned so as to form a substantially constant air gap there between.

2. The generator machine of claim 1 wherein the number of the at least two salient poles is 2N, where N is an integer greater than or equal to two.

3. The generator machine of claim 1 wherein the at least two salient poles protect from flux movement in at least two directions by comprising poles where at least a portion of the pole is fabricated from a different metal.

4. The generator machine of claim 1 wherein the at least two salient poles protect from flux movement in at least two directions by comprising poles where at least a portion of the pole is fabricated using a predetermined grain orientation.

5. The generator machine of claim 1 wherein the at least two salient poles protect from flux movement in at least two directions by comprising poles where at least a portion of the pole is fabricated using ferrite materials.

6. The generator machine of claim 1 wherein the at least two salient poles protect from flux movement in at least two directions by comprising poles where at least a portion of the pole is fabricated using distributed air gap material.

7. The generator machine of claim 1 wherein the at least two salient poles protect from flux movement in at least two directions by comprising poles where at least a portion of the pole is fabricated using sintered steel material

8. The generator machine of claim 1 wherein the at least two salient poles protect from flux movement in at least two directions by comprising poles where at least a portion of the pole is fabricated from laminations disposed at right angles with respect to one another.

9. The generator machine of claim 1 wherein the flux path element is substantially elliptical in shape and is mounted on the shaft at an oblique angle with respect to the longitudinal axis of the shaft.

10. The flux path element of claim 9 wherein the substantially elliptical shape can be described with reference to a circle with a radius r at an angle θ measured from the center of the circle and in the plane of the circle;
wherein a radius R, may be drawn at an angle of inclination a from the plane of the circle and at a length given by R=(r²+(r sin α)²)^{1/2}; and
wherein the perimeter of the substantially elliptical shape is described by rotating R about the full 360 degrees of angle θ about the reference circle.

11. The generator machine of claim 1 wherein the flux path element comprises a stack of laminated, magnetically conductive disks.

12. The generator machine of claim 1 wherein the flux path element comprises silicone steel lamination.

13. The generator machine of claim 1 wherein the flux path element comprises sintered steel alloys.

14. The generator machine of claim 1 wherein the flux path element comprises a distributed air gap material.

15. The generator machine of claim 1 wherein the induced voltage created in the power windings by a change in magnetic flux further comprises an output frequency related to the angular velocity of the shaft.

16. The generator machine of claim 15, wherein, for a given output frequency, the angular velocity of the shaft is a multiplier of a conventional shaft angular velocity.

17. The generator machine of claim 16, wherein the multiplier of the conventional shaft angular velocity is 1/N, and where N is the number of salient poles in the stator assembly.

18. The generator machine of claim 1 further comprising at least two field windings and wherein each field winding is configured to produce a magnetic flux of substantially the same magnitude, but substantially opposite polarity.

19. The generator machine of claim 1 wherein the rotor assembly is configured to act as a swash plate when it is impinged upon by Lenz forces which are parallel to the axis of rotation.

20. The rotor assembly of claim 19 wherein the action of the swash plate enables a lower average torque requirement to rotate the rotor assembly shaft.

21. The generator machine of claim 1 wherein the magnetic flux created by the at least one field winding mechanically changes its direction under the operation of the rotor assembly.

22. The generator machine of claim 1 wherein the at least one field winding has a conductor size and number of turns at a predetermined amount to establish a magnetic flux of a predetermined value and keep copper losses to a minimum.

23. The generator machine of claim 1 wherein rotational speed of the shaft increases when the impedance of an output electric load approaches a short circuit condition.

24. An electric generator with reduced Back Torque comprising:
a stator assembly further comprising:
at least four salient poles each having a face, and arranged in pairs located on opposite sides of a longitudinal axis of the stator assembly;
each salient pole further comprising a field winding and a power winding, wherein the field windings on opposite salient poles of each pair are wound to create a magnetic flux of equivalent magnitude, but opposite polarity;
a rotor assembly further comprising:
a shaft;
a flux path element located on the shaft and wherein rotation of the shaft causes a flux coupling zone related to the flux path element to oscillate along the face of a salient pole;
the stator assembly and rotor assembly being located in a manner that creates a substantially constant air gap between the stator assembly and the rotor assembly.

25. The electric generator of claim 24 wherein an induced voltage created in the power windings by a change in magnetic flux has an output frequency related to the angular velocity of the shaft.

26. The electric generator of claim 25, wherein, for a given output frequency, the angular velocity of the shaft is a multiplier of a conventional shaft angular velocity.

27. The electric generator of claim 26, wherein the multiplier of the angular velocity is 1/N, and where N is the number of salient poles in the stator assembly.

28. The electric generator of claim 25 wherein the power windings of each pair of the at least four salient poles generates a single phase output for a combined two phase output.

29. The electric generator of claim 28 wherein the number of electric output phases of the generator is N/2 phases, and where N is the number of salient poles in the stator assembly.

30. The electric generator of claim 24 where the oscillation of the flux coupling zone along the face a salient pole causes a force that is directed parallel to the axis of rotation of the shaft.

31. The electric generator of claim 30 wherein the force directed parallel to the axis of rotation of the shaft enables a lower average torque requirement to rotate the shaft.

32. The electric generator of claim 24 wherein the at least four salient poles are arranged to minimize eddy currents, hysteresis loops, or iron losses by protecting from flux movement in at least two directions.

33. The generator machine of claim 32 wherein the at least four salient poles protect from flux movement in at least two directions by comprising poles where at least a portion of the pole is fabricated from a different metal.

34. The generator machine of claim 32 wherein the at least four salient poles protect from flux movement in at least two directions by comprising poles where at least a portion of the pole is fabricated using a predetermined grain orientation.

35. The generator machine of claim 32 wherein the at least four salient poles protect from flux movement in at least two directions by comprising poles where at least a portion of the pole is fabricated using ferrite materials.

36. The generator machine of claim 32 wherein the at least four salient poles protect from flux movement in at least two directions by comprising poles where at least a portion of the pole is fabricated using distributed air gap material.

37. The generator machine of claim 32 wherein the at least four salient poles protect from flux movement in at least two directions by comprising poles where at least a portion of the pole is fabricated using sintered steel material

38. The generator machine of claim 32 wherein the at least four salient poles protect from flux movement in at least two directions by comprising poles where at least a portion of the pole is fabricated from laminations disposed at right angles with respect to one another.

39. The generator machine of claim 24 wherein rotational speed of the shaft increases when the impedance of an output electric load approaches a short circuit condition.

40. An electrodynamic machine comprising:
a stator assembly comprising:
at least two salient poles arranged to protect from flux movement in at least two directions;
at least one field winding that when energized creates a magnetic flux; and
a rotor assembly comprising;
a shaft;
a flux path element mounted on the shaft and configured to direct magnetic flux through a flux zone, and wherein the flux path element is further configured to magnetically couple pairs of the at least two salient poles by providing a low-reluctance path between the pairs, and
wherein the rotation of the shaft enables the flux path element to vary the location of the flux zone in a periodic fashion; and
wherein the position of maximum flux concentration alternates from a relative minimum position to a maximum displacement during the periodic varying of location without undergoing a reversal of flux polarity.

41. The electrodynamic machine of claim 40 wherein rotational speed of the shaft increases when the impedance of an output electric load approaches a short circuit condition.

42. The electrodynamic machine of claim 40 wherein the number of the at least two salient poles is 2N, where N is an integer greater than or equal to two.

43. The electrodynamic machine of claim 40 wherein the at least two salient poles protect from flux movement in at least two directions by comprising poles where at least a portion of the pole is fabricated from a different metal.

44. The electrodynamic machine of claim 40 wherein the at least two salient poles protect from flux movement in at least two directions by comprising poles where at least a portion of the pole is fabricated using a predetermined grain orientation.

45. The electrodynamic machine of claim 40 wherein the at least two salient poles protect from flux movement in at least two directions by comprising poles where at least a portion of the pole is fabricated using ferrite materials.

46. The electrodynamic machine of claim 40 wherein the at least two salient poles protect from flux movement in at least two directions by comprising poles where at least a portion of the pole is fabricated using distributed air gap material.

47. The electrodynamic machine of claim 40 wherein the at least two salient poles protect from flux movement in at least two directions by comprising poles where at least a portion of the pole is fabricated using sintered steel material

48. The electrodynamic machine of claim 40 wherein the at least two salient poles protect from flux movement in at least two directions by comprising poles where at least a portion of the pole is fabricated from laminations disposed at right angles with respect to one another.

49. The electrodynamic machine of claim 40 wherein the flux path element is substantially elliptical in shape and is mounted on the shaft at an oblique angle with respect to the longitudinal axis of the shaft.

50. The flux path element of claim 49 wherein the substantially elliptical shape can be described with reference to a circle with a radius r at an angle θ measured from the center of the circle and in the plane of the circle;
wherein a radius R, may be drawn at an angle of inclination a from the plane of the circle and at a length given by R=(r²+(r sin α)²)^{1/2}; and
wherein the perimeter of the substantially elliptical shape is described by rotating R about the full 360 degrees of angle θ about the reference circle.

51. The electrodynamic machine of claim 40 wherein the flux path element comprises a stack of laminated, magnetically conductive disks.

52. The electrodynamic machine of claim 40 wherein the flux path element comprises silicone steel lamination.

53. The electrodynamic machine of claim 40 wherein the flux path element comprises sintered steel alloys.

54. The electrodynamic machine of claim 40 wherein the flux path element comprises a distributed air gap material.

55. The electrodynamic machine of claim 40 wherein the induced voltage created in the power windings by a change in magnetic flux further comprises an output frequency related to the angular velocity of the shaft.

56. The electrodynamic machine of claim 55, wherein, for a given output frequency, the angular velocity of the shaft is a multiplier of a conventional shaft angular velocity.

57. The electrodynamic machine of claim 56, wherein the multiplier of the angular velocity is 1/N, and where N is the number of salient poles in the stator assembly.

58. The electrodynamic machine of claim 40 further comprising at least two field windings and wherein each field winding is configured to produce a magnetic flux of substantially the same magnitude, but substantially opposite polarity.

59. The electrodynamic machine of claim 40 wherein the rotor assembly is configured to act as a swash plate when it is impinged upon by Lenz forces which are parallel to the axis of rotation.

60. The rotor assembly of claim 59 wherein the action of the swash plate enables a lower average torque requirement to rotate the rotor assembly shaft.

61. The electrodynamic machine of claim 40 wherein the magnetic flux created by the at least one field winding mechanically changes its direction under the operation of the rotor assembly.

62. The electrodynamic machine of claim 40 wherein the at least one field winding has a conductor size and number of turns at a predetermined amount to establish a magnetic flux of a predetermined value and keep copper losses to a minimum.
